(19) United States
(12) Patent Application Publication
(10) Pub. No.: US 2013/0226052 A1
(43) Pub. Date: Aug. 29, 2013

(54) MULTIFUNCTIONAL HANDHELD SELF MASSAGE DEVICE

(71) Applicant: Dale Allen Niggemann, Stevens Point, WI (US)

(72) Inventor: Dale Allen Niggemann, Stevens Point, WI (US)

(21) Appl. No.: 13/403,986

(22) Filed: Feb. 24, 2012

(51) Int. Cl. A61H 15/00

(52) U.S. Cl. 601/118

(57) ABSTRACT

A multifunctional handheld self massage device including an elongated rod rotatably connected to a curved rod. The curved rod is connected at its other end to either a pair of parallel massage rollers, an easy disconnect end which allows for the connection of any number of different massage heads, or a rotatable massage unit.

### CROSS-REFERENCE TO RELATED APPLICATIONS

This application claims the benefit of U.S. Provisional Patent Application No. 61/463,849 filed on Feb. 23, 2011

### BACKGROUND OF THE INVENTION

1. Field of Invention

The present invention generally relates to massage devices and, more particularly, is concerned with a multifunctional handheld self massage device.

2. Description of the Prior Art

Massages have been administered by masseurs for centuries and the benefit and comfort of muscle massage is widely recognized. Attempts to translate the benefits and comforts of a professional massage into a self massage device have been ongoing since the commencement of consumer devices. Of particular concern are the areas around the spine and shoulders which contain muscles that are highly desirable to massage yet hard to reach. Another area in which the benefits and comforts of a professional massage are attempted to be translated is with trigger point therapies which stimulate healing, increase blood flow, and helps range of motion for the body's appendages.

Hand held massage devices which are curved to enable a user to self massage their back are well known. Some examples of the various means of enabling back massage are shown in the following prior art U.S. Pat. Nos. 4,266,536; 5,560,746; 6,261,251; 2005/0113726 A1. Additionally U.S. Pat. No. D595,901S. shows an example of a massage device which allows for trigger point massaging of the back.

U.S. Pat. Nos. 4,266,536; 5,560,746; 6,261,251; 2005/0113726 A all fall short because they are too large and bulky to be easily packed into a backpack or suitcase and therefore lack portability. Since a massage device of this nature maybe needed at work, home, or while traveling, this lack of portability is a serious defect. U.S. Pat. No. D595,901S falls short because it can only be used for trigger point massaging and lacks the versatility needed to properly translate the benefits and comforts of a professional massage.

### BRIEF SUMMARY OF THE INVENTION

The present invention provides a multifunctional handheld self massage device that enables a user to massage hard to reach areas in a variety of ways while still being highly portable.

The present invention relates to a multifunctional handheld self massage device having an elongated rod, that is used as a handle, connected rotatably to a curved rod, which is in turn connected to a massage device. The elongated rod allows a user to reach over their back and easily massage. The connection point that can rotate allows for easy storage and travel.

In some embodiments the rod that is used as a handle can be disconnected enabling a handle of different shapes and features to be connected in its place. This allows users to change handles so the massage device can be used in a variety of ways.

In some embodiments the curved rod can be disconnected enabling a curved rod of different shapes and features to be connected in its place. This allows users to change the shape of the curved rod in order to reach various body parts.

In some embodiments the massage device that is connected to the curved rod is a pair of parallel massage rollers positioned such that they rotate in a plane parallel to the curved rod allowing the user to massage both sides of the spine at once.

In some embodiments the massage device is replaced with an easy disconnecting device which allows different massage devices to be connected and disconnected depending on what type of massage is desired.

In some embodiments a set of rotational massagers are attached along the elongated rod such that the rotational massagers rotate perpendicular to the elongated rod allowing a user to apply a roller massage to his quadriceps, hamstrings, foot, sciatica, and buttocks.

In some embodiments the massage device is replaced with a rotatable massage device that can rotate to allow various massage head to be used. This allows a user the ability to quickly change the type of massage device he is using without having to disconnect the massage heads.

### BRIEF DESCRIPTION OF THE DRAWINGS

FIG. 1. displays a side view of an embodiment of the present invention.

FIG. 2. displays an exploded view of an embodiment of the present invention.

FIG. 3. displays an enlarged view of a quick disconnect end.

FIG. 4. displays a side view of an embodiment of the present invention.

FIG. 5 displays an enlarged view of a quick disconnect handle.

FIG. 6 displays an enlarged view of a quick disconnect curved rod.

FIG. 7 shows the multifunctional handheld self massage device in use.

FIG. 8 shows the multifunctional handheld self massage device in use.

FIG. 9 shows the multifunctional handheld self massage device in use.

FIG. 10 shows an enlarged view of a rotatable massage unit.

### DETAILED DESCRIPTION OF THE DRAWINGS

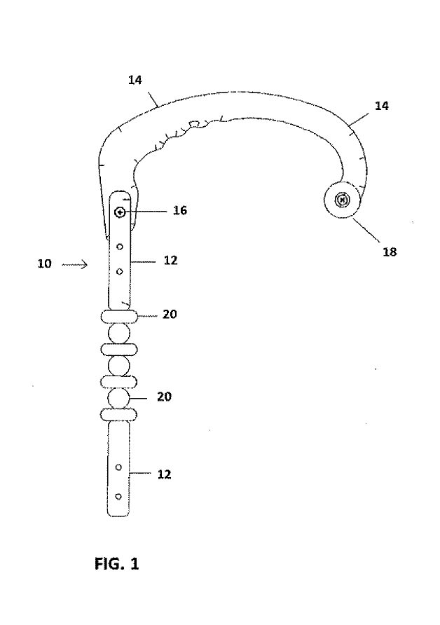

Referring now to the drawing, and more particularly, to FIG. 1, there is shown a multifunctional handheld self massage device generally designated 10, which comprises the preferred embodiment of the present invention. The multifunctional handheld self massage device 10, basically includes an elongated rod 12, a curved rod 14, a rotatable joint 16, pair of parallel massage rollers 18, and rotational massagers 20.

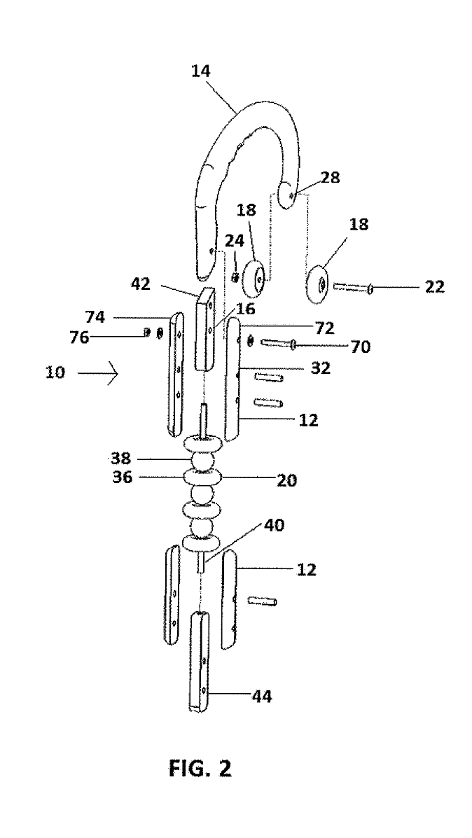

As shown in FIG. 2, the multifunctional handheld self massage device 10 is comprised as follows: a pair of parallel massage rollers 18 secured to one end 32 of the curved rod 14 by means of a nut 22 and bolt 24. The bolt 24 first goes through one massage roller 18 then through a hole 28 in the end of the curved rod 14 then through the other massage roller 18. This allows the parallel massage rollers 18 to rotate freely.

The elongated rod 12 is made up of a top section 32, a set of rotational massagers 20, and a bottom section 34. The set of rotational massagers 20 are created by placing a metal rod 40 through any number of wheels 36 or balls 38 with holes through the middle. This metal rod 40 is then inserted into a wooden peg at the top end 42 and bottom end 44. The rotatable joint 16 is then created by placing a screw 70 through two side covers 72 and 74, with the top end 42 wooden peg in the middle. The screw 70 is secured with a nut 76. This allows the rotatable joint 16 to rotate.

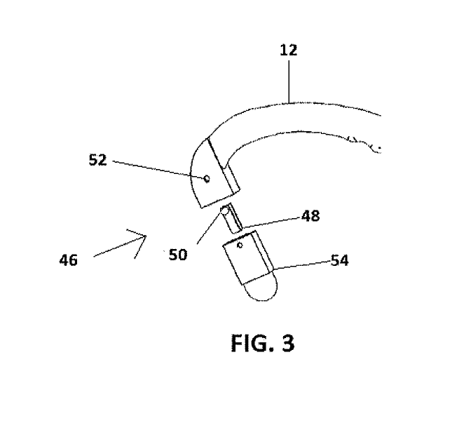

As shown in FIG. 3, in another embodiment of this invention there is the use of an easy disconnect end 46, in this embodiment a quick-release button connector 48 is used. The quick-release button connector 48 is pinched and inserted into the easy disconnect end. The button 50 then pops out the hole 52 of the quick-release disconnect end 46 and holds the massage device 54 in place. This allows many different kind of massage heads to be connected and disconnected to the curved rod 14 depending on what type of massage head the user desires. Other possible easy disconnect systems include threaded screws, ball and socket connectors, magnetism, various pins systems, allen key systems, and spring pins.

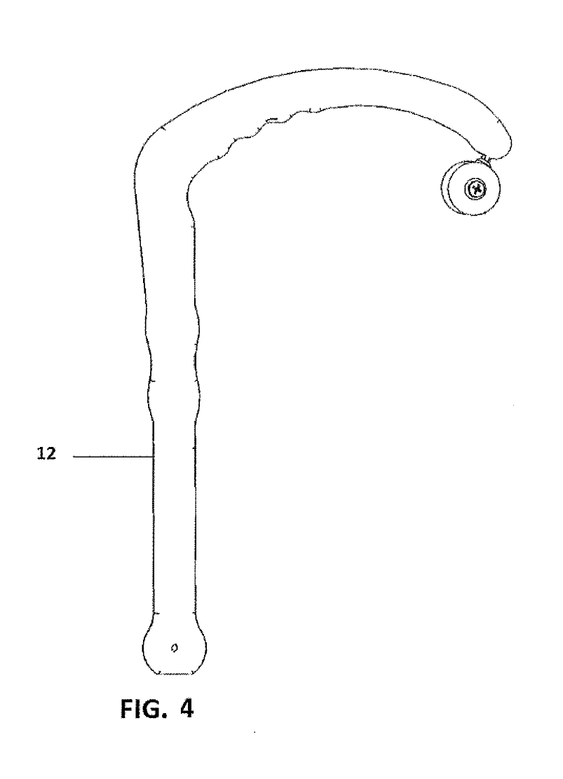

As shown in FIG. 4 in another embodiment of this invention the elongated rod 12 is one solid piece of wood and is not bisected by a set of rotational massagers 20 as shown in FIG. 1.

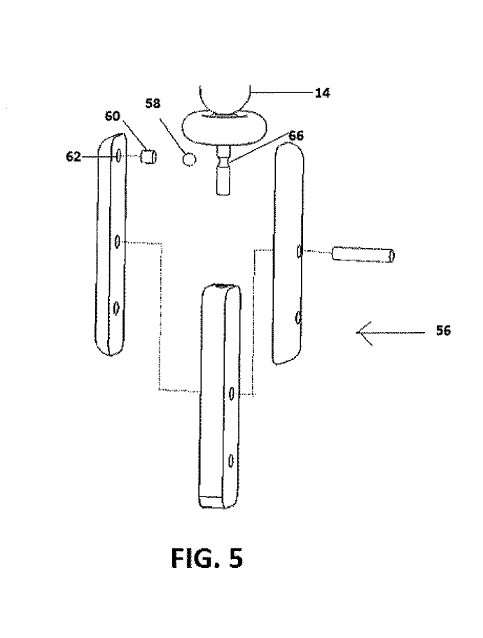

FIG. 5. shows an exploded view of how the handle 56 detaches. A ball 58 and spring 60 system is used, the spring is inserted into a hole 62 of the first handle cover 64. When the metal rod 40 is inserted into the handle 56 the spring 60 compresses and then expands slightly when the metal rod 40 is fully inserted and the notch 66 is in line with the hole 62. The expansion of the spring 60 pushes the ball 58 into the notch 66 holding the handle 56 in place firmly unless pulled directly out with strong force. This allows for many different kind of handles to be connected and disconnected to the elongated rod 14 depending on what type of handle the user desires. Other possible easy disconnect systems include threaded screws, ball and socket connectors, magnetism, various pins systems, allen key systems, and spring pins.

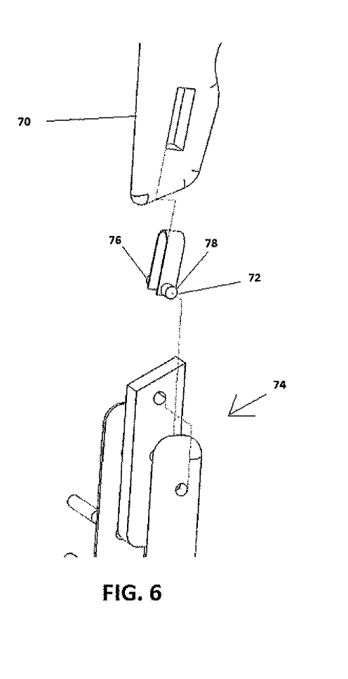

FIG. 6 shows an exploded view of the easily detachable curved rod 70. The easily detachable curved rod 70 works much like the easy disconnect end 46 in FIG. 3. The easily detachable curved rod's quick-release button connector 72 is pinched and inserted into the top of the elongated rod 74. The easily detachable curved rod's quick-release button connector 72 then springs back out and the two buttons 76 and 78 hold the easily detachable curved rod 70 in place and allow it to rotate. This allows for many different kinds of curved rods to be connected and disconnected to the elongated rod 14 depending on what type of curved rod the user desires. Other possible easy disconnect systems include threaded screws, ball and socket connectors, magnetism, various pins systems, allen key systems, and spring pins.

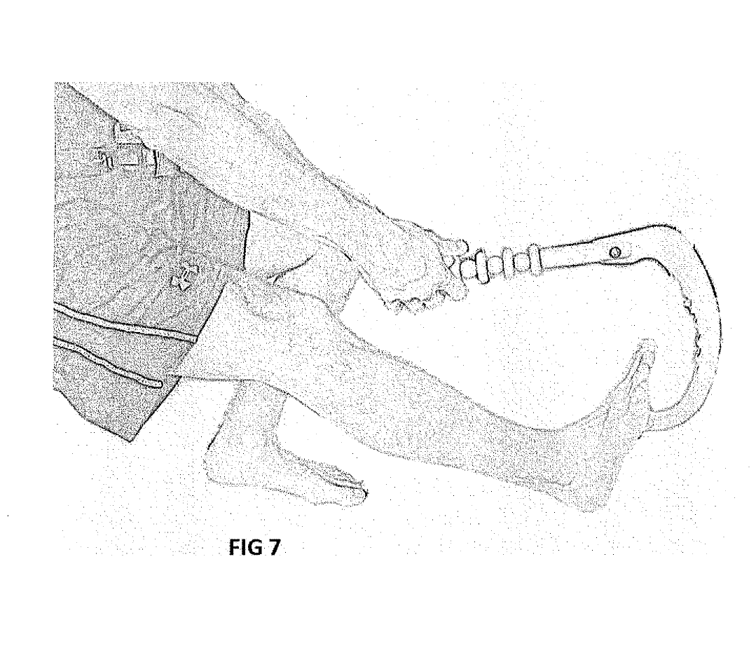

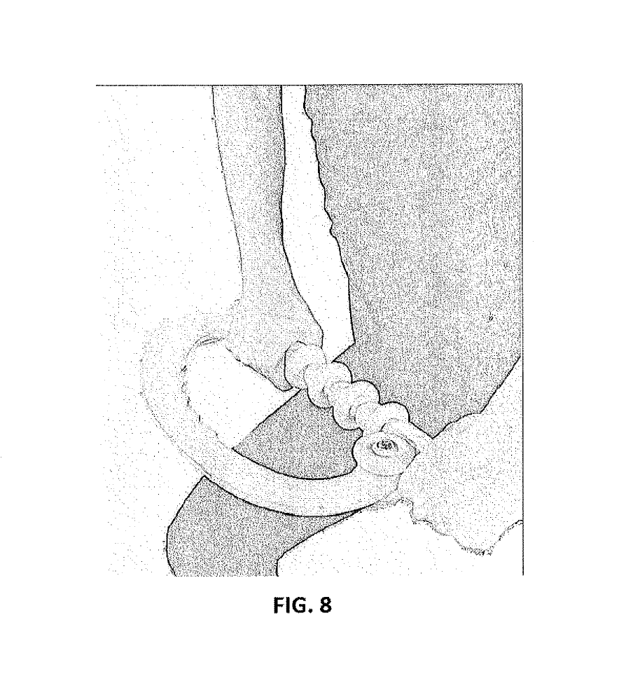

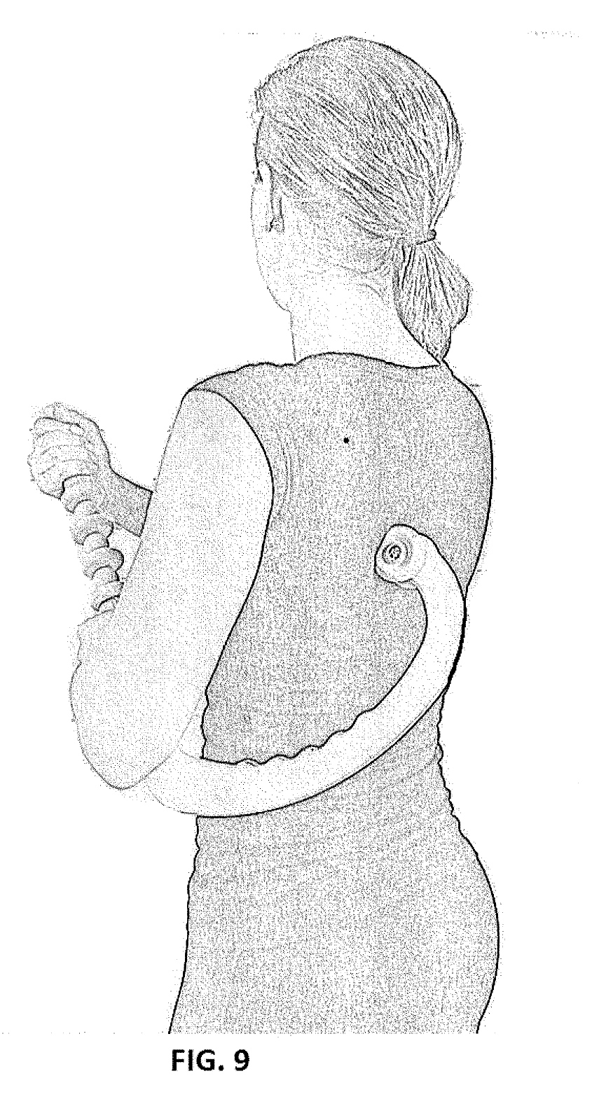

Several different ways to use the multifunctional handheld self massage device are shown in FIG. 7, FIG. 8 and FIG. 9.

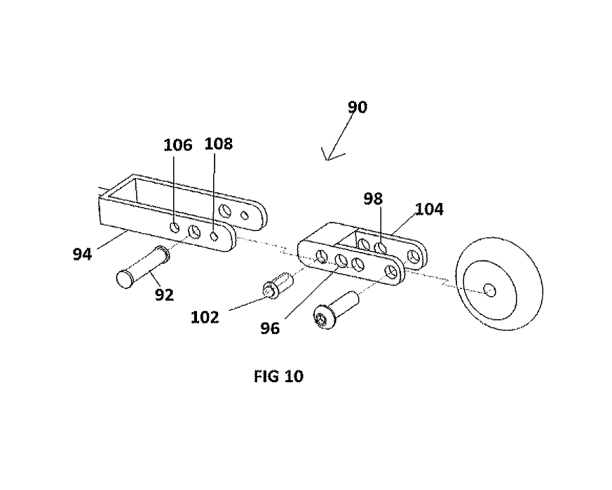

FIG. 10 shows a rotatable massage unit 90 which works by placing a metal pin 92 through the first side of a bracket 94 then both holes 96 and 98 of the rotating member 104 and 98 then the second side of the bracket 100. This allows the rotating member 96 to freely rotate. The rotating member 96 is held in place when the spring button 102 connected to it encounters either of the holes 106 and 108 in the bracket 94. The spring button 102 will hold the rotating member 80 in place until it is pushed in.

What is claimed is:

1. A massage device, comprising:
(a) an elongated rod having a first and second end;
(b) a curved rod having a first and second end;
(c) a pair of parallel massage rollers positioned on said second end of curved rod such that said rollers rotate in a plane parallel to said second end of curved rod;
(d) a rotatable joint between said second end of elongated rod and said first end of curved rod, such that said second end of curved rod and said first end of elongated rod can rotate toward each other.

2. The massage device as recited in claim 1, further comprising a set of rotational massagers attached to said elongated rod and rotating perpendicular to said elongated rod's plane.

3. A massage device, comprising:
(a) an elongated rod having a first and second end;
(b) a curved rod having a first and second end;
(c) an easy disconnection end positioned on the said second end of curved rod;
(d) a rotatable joint between said second end of elongated rod and said first end of curved rod, such that said second end of curved rod and said first end of elongated rod can rotate toward each other.

4. The massage device as recited in claim 3, further comprising a set of rotational massagers attached to said elongated rod and rotating perpendicular to said elongated rod's plane.

5. The massage device as recited in claim 3, wherein the rotatable joint comprises a feature that allows easy disconnection of said first end of curved rod and said second end of elongated rod.

6. The massage device as recited in claim 3, wherein the said first end of elongated rod has a feature that allows easy disconnection of said first end of elongated rod.

7. A massage device, comprising:
(a) an elongated rod having a first and second end;
(b) a curved rod having a first and second end;
(c) a rotatable massage unit connected to said second end of curved rod;
(d) two or more massage devices connected to said message unit;
(e) a rotatable joint between said second end of elongated rod and said first end of curved rod, such that said second end of curved rod and said first end of elongated rod can rotate toward each other.
